(19) United States
(12) Patent Application Publication
(10) Pub. No.: US 2020/0369243 A1
(43) Pub. Date: Nov. 26, 2020

(54) ON-VEHICLE DEVICE

(71) Applicant: KABUSHIKI KAISHA TOKAI RIKA DENKI SEISAKUSHO, Aichi (JP)

(72) Inventors: Rijin OWAKI, Aichi (JP); Yosuke OHASHI, Aichi (JP); Fumitaka YOSHIKAWA, Aichi (JP); Yuji FUKANO, Aichi (JP)

(21) Appl. No.: 16/768,855

(22) PCT Filed: Nov. 16, 2018
(86) PCT No.: PCT/JP2018/042577

§ 371 Date: Jun. 1, 2020

(30) Foreign Application Priority Data
Dec. 4, 2017 (JP) 2017-232372

(51) Int. Cl. B60R 25/25; G06K 9/00

(52) U.S. Cl. CPC B60R 25/252; G06K 9/00892; B60R 25/255

(57) ABSTRACT

An on-board device includes a storage unit that stores biometric information of a user of a vehicle that is used for authentication, and a control unit that increases difficulty of authenticating biometric information not having been used for authentication for a predetermined period or deletes such biometric information from the storage unit.

### CROSS-REFERENCES TO RELATED APPLICATION

The present patent application claims the priority of Japanese patent application No. 2017/232372 filed on Dec. 4, 2017, and the entire contents of Japanese patent application No. 2017/232372 are hereby incorporated by reference.

### TECHNICAL FIELD

The present invention relates to an on-board device.

### BACKGROUND ART

A vehicle anti-theft device is known, which is provided with a mobile device authentication means which authenticates a mobile device based on identification information received from the mobile device, a driver authentication means which acquires driver identification information unique to a driver and authenticates the driver as a pre-registered driver based on comparison with pre-registered driver identification information, an information input means receiving an input of setting information which is information set by the registered driver, and an authentication control means which selects either authentication using the driver authentication means or authentication based on the setting information input by the registered driver and controls start of a vehicle based on an authentication result from the selected authentication and an authentication result provided by the mobile device authentication means (see. e.g., Patent Literature 1).

This vehicle anti-theft device uses biometric information of the driver as the driver identification information.

### CITATION LIST

### Patent Literature

Patent Literature 1: JP 2010/208554 A

### SUMMARY OF INVENTION

### Technical Problem

In case of the vehicle anti-theft device disclosed in Patent Literature 1, if, e.g., unnecessary biometric information not used for authentication is present, authentication based on such unnecessary biometric information is also carried out and this may cause an increase in time spent on authentication.

It is an object of the invention to provide an on-board device which can suppress an increase in time spent on authentication.

### Solution to Problem

According to an embodiment of the invention, an on-board device comprises: a storage unit that stores biometric information of a user of a vehicle that is used for authentication, and a control unit that increases difficulty of authenticating biometric information not having been used for authentication for a predetermined period or deletes such biometric information from the storage unit.

### Advantageous Effects of Invention

According to an embodiment of the invention, it is possible to provide an on-board device which can suppress an increase in time spent on authentication.

### BRIEF DESCRIPTION OF DRAWINGS

FIG. 1A is a block diagram illustrating an on-board device in an embodiment.

FIG. 1B is an explanatory diagram illustrating a table stored in the on-board device in the embodiment.

FIG. 2 is a flowchart of the on-board device in the embodiment.

FIG. 3 is a flowchart of the on-board device in another embodiment.

### DESCRIPTION OF EMBODIMENTS

### Summary of the Embodiments

An on-board device in an embodiment has a storage unit that stores biometric information of a user of a vehicle that is used for authentication, and a control unit that increases difficulty of authenticating biometric information not having been used for authentication for a predetermined period or deletes such biometric information from the storage unit.

This on-board device increases difficulty of authenticating biometric information not having been used for authentication or deletes such biometric information from the storage unit. Therefore, unlike when such a configuration is not adopted, frequency of authentication using biometric information not having been used for authentication is reduced or authentication using biometric information not having been used for authentication is not carried out, hence, it is possible to suppress an increase in time spent on authentication.

### EMBODIMENT

(General Configuration of On-Board Device 1)

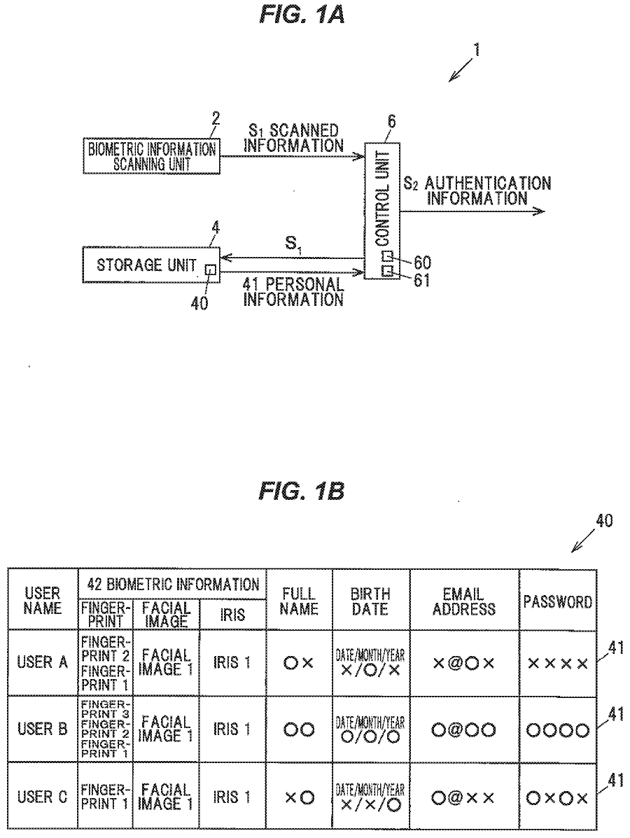

FIG. 1A is a block diagram illustrating an on-board device in an embodiment, and FIG. 1B is an explanatory diagram illustrating a table stored in the on-board device in the embodiment. In FIG. 1A, flows of main information are indicated by arrows.

An on-board device 1 is mounted on a vehicle 8 to manage personal information 41 of users including the owner of the vehicle 8. The vehicle 8 here is used by, e.g., plural users (User A to User C, as an example), as shown in FIG. 1B. In addition, a table 40 is provided to prioritize and manage the personal information 41 of the users.

The on-board device 1 has, e.g., a storage unit 4 which stores biometric information 42 of a user of a vehicle which is used for authentication, and a control unit 6 which increases difficulty of authenticating the biometric information 42 not having been used for authentication for a predetermined period or deletes such biometric information 42 from the storage unit 4, as shown in FIGS. 1A and 1B.

In the present embodiment, the case where the biometric information 42 not having been used for authentication for a predetermined period is deleted from the storage unit 4 will be described.

In case of deleting the biometric information 42 not having been used for authentication for a predetermined period from the storage unit 4, and when all the biometric information 42 stored in the storage unit 4 have not been used for authentication, the control unit 6 deletes the personal information 41 of all users stored in the storage unit 4 together with all the biometric information 42.

When deleting all the biometric information 42, the control unit 6 initializes the personal information 41 of all users, i.e., initializes the table 40.

The biometric information 42 in the present embodiment includes, as an example, fingerprint, facial image, iris, etc., used to create a biometric authentication template as shown in FIG. 13, but may include vein, etc. However, it is not limited thereto. In addition, in the present embodiment, information including, e.g., the user name and the biometric information 42 is used as the personal information 41, as shown in FIG. 1B.

As an example, full name, birth date, email address, password, etc., are included in the personal information 41, as shown in FIG. 1B.

The on-board device 1 is further provided with, e.g., a biometric information scanning unit 2 which scans the biometric information 42, as shown in FIG. 1A.

(Configuration of the Biometric Information Scanning Unit 2)

The biometric information scanning unit 2 is provided to, e.g., scan the biometric information 42 of the user. As an example, the biometric information scanning unit 2 is mounted on a start switch for giving an instruction to turn on/off a drive system of the vehicle. Alternatively, as an example, the biometric information scanning unit 2 may be configured to scan facial image or iris as the biometric information 42 to perform authentication for an electronic device other than the start switch.

In this case, the biometric information scanning unit 2 scans, e.g., a fingerprint or vein of an operation finger operating the start switch. Then, based on comparison between the scanned data and the biometric information 42 which is a template stored in the storage unit 4 of the on-board device 1 and used for authentication of the fingerprint or vein, the control unit 6 determines whether or not the operator is the registered person.

The biometric information scanning unit 2 is also configured to be able to perform registration of the biometric information 42. As an example, the biometric information scanning unit 2 associates the biometric information 42 such as fingerprint, facial image, iris, etc., with the user name and causes the storage unit 4 to store it as the table 4, as shown in FIG. 1B. However, registrable biometric information 42 is not limited thereto and may include vein, pulse rate, blood pressure, etc.

Fingerprint is registered using, e.g., a sensor configured to read the fingerprint pattern, such as optical, capacitive, electrical field intensity measurement, pressure-sensitive, or thermal, etc.

Vein of an operating finger or palm is registered using, e.g., a sensor configured to read the vein pattern based on reflection of emitted infrared light.

Facial image is registered using, e.g., a sensor configured to read an uneven shape on a subject based on depths at plural measurement points on the captured subject.

Iris is registered using, e.g., a sensor configured to read an iris by emitting infrared light and processing the captured image.

The biometric information scanning unit 2 generates and outputs, e.g., scanned information S₁ which is information about the scanned biometric information 42.

(Configuration of the storage unit 4) The storage unit 4 is constructed from, e.g., a HDD (Hard Disk Drive) or a semiconductor memory, etc. The storage unit 4 in the present embodiment is a semiconductor memory. This semiconductor memory may be a RAM mounted on the control unit 6.

The storage unit 4 is configured to generate, e.g., the table 40 based on the scanned information S₁ acquired from the biometric information scanning unit 2, as shown in FIGS. 1A and 1B.

The table 40 contains, e.g., the personal information 41 such as fingerprint associated with each user, as shown in FIG. 13. In FIG. 13, the personal information 41 of the user A to the user C, who share the vehicle, are shown as an example.

In addition, in the table 40, for example, the users are arranged in order of priority, and the biometric information 42 (one or more data can be registered as the biometric information 42) are also arranged in order of priority. For the users, the priority is set in order of, e.g., the user B, the user A and the user C. This priority is, e.g., the descending order of usage frequency of the vehicle. Furthermore, for the fingerprints registered by the user B, the priority is set in order of, e.g., a fingerprint 2 and a fingerprint 1. This priority is, e.g., the descending order of frequency of authentication.

(Configuration of the Control Unit 6)

The control unit 6 is, e.g., a microcomputer composed of a CPU (Central Processing Unit) performing calculation and processing, etc., of the acquired data according to a stored program, and a RAM (Random Access Memory) and a ROM (Read Only Memory) which are semiconductor memories, etc. The ROM stores, e.g., a program for operation of the control unit 6, an authentication threshold 60 and history information 61. The RAM is used as, e.g., a storage area for temporarily storing calculation results, etc. The control unit 6 also has, inside thereof, a means for generating a clock signal, and operates based on the clock signal.

In case of authentication with, e.g., fingerprint, the authentication threshold 60 is the number of feature points on the fingerprint. In case that the authentication threshold 60 is “70” and when the number of matched feature points is not less than 70 out of the feature points (100 points) in the fingerprint template, the control unit 6 determines that it is the registered person.

When authentication is successful, the control unit 6 outputs authentication information S₂, which indicates successful authentication, to a connected electronic device.

The history information 61 is generated by, e.g., arranging the biometric information 42 used for authentication in time series and also adding usage frequency information to each biometric information 42. The control unit 6 updates the history information 61 each time authentication is performed. Then, based on the history information 61, the control unit 6 can select the biometric information 42 which has not been used for authentication for a predetermined period. The predetermined period is about one year, as an example.

Here, in case that, e.g., the owner of the vehicle has changed and the personal information 41 of a previous owner is left, it may be abused or may remain as a candidate biometric information 42 for authentication and result in that authentication takes long time. In this case, e.g., the biometric information 42 of the user A to the user C shown in FIG. 1B is not being used for authentication since the owner has changed. Therefore, the control unit 6 deletes the personal information 41 of all the user A to the user C when the biometric information 42 of all the user A to the user C are not used for authentication for a predetermined period.

For example, as a method of deleting the personal information 41, the control unit 6 initializes the table 40. By this initialization, the control unit 6 deletes, e.g., all the personal information 41 registered by the user A to the user C shown in FIG. 13.

Meanwhile, when the biometric information 42 registered by the user is, e.g., not optimal and is not successfully authenticated for a predetermined period, only such non-optimal biometric information 42 is deleted. When, e.g., the fingerprint 2 of the user A shown in FIG. 1B is obtained from a cut finger, or is not accurately scanned, and is not successfully authenticated for a predetermined period, the control unit 6 deletes the fingerprint 2. This deletion suppresses an increase in time spent on authentication of the biometric information 42.

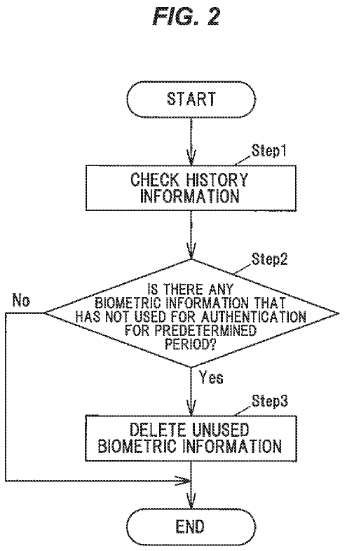

An example of an operation of the on-board device 1 in the present embodiment will be described below along with the flowchart in FIG. 2.

(Operation)

The control unit 6 of the on-board device 1 checks the history information 61 (Step 1). In detail, the control unit 6 checks, e.g., usage status of the biometric information 42 at a preset timing.

Then, the control unit 6 checks whether or not there is any biometric information 42 which has not been used for authentication for a predetermined period. When the biometric information 42 not having been used for authentication is present (Step 2: Yes), the control unit 6 deletes the biometric information 42 not having been used for authentication (Step 3) and ends the process.

When, e.g., all the biometric information 42 in the table 40 have not been used for authentication, the control unit 6 initializes the table 40 to delete all the personal information 41. Meanwhile, when, e.g., a certain biometric information 42 among plural biometric information 42 has not been used for authentication, the control unit 6 deletes such biometric information 42.

Meanwhile, when the biometric information 42 not having been used for authentication for a predetermined period is not present in Step 2 (Step 2: No), the control unit 6 ends the process.

### Effect of the Embodiment

The on-board device 1 in the present embodiment can suppress an increase in time spent on authentication. In detail, the on-board device 1 deletes the biometric information 42 not having been used for authentication from the table 40. Therefore, unlike when such a configuration is not adopted, authentication using the biometric information 42 not having been used for authentication is not carried out, hence, it is possible to suppress an increase in time spent on authentication.

Even when the owner of the vehicle has changed and the biometric information 42 of the previous owner is left, the biometric information 42 of the previous owner will not remain and can be prevented from being abused since the on-board device 1 deletes all the biometric information 42 not having been used for authentication from the table 40, unlike when such a configuration is not adopted. In addition, since the on-board device 1 can initialize the table 40 and thereby delete the personal information 41 which includes the biometric information 42 and has been left undeleted, user's privacy is protected.

As another embodiment, in case of increasing difficulty of authenticating the biometric information 42 not having been used for authentication for a predetermined period, the control unit 6 is configured to increase a threshold (the authentication threshold 60) for authenticating the biometric information 42 not having been used for authentication.

In detail, when increasing difficulty of authentication, the control unit 6 changes the authentication threshold 60 for the biometric information 42 not having been used for authentication for a predetermined period, from “70” to “80”, “95” or “100”, etc., as an example.

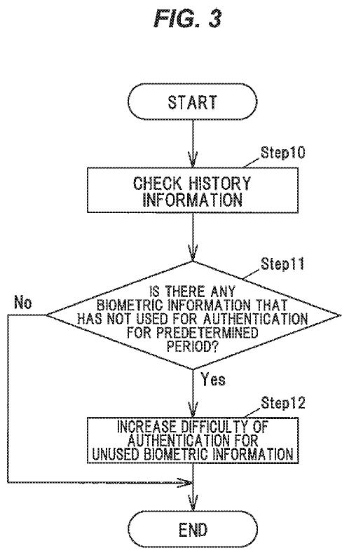

Next, an example of an operation of the on-board device 1 in the other embodiment will be described along with the flowchart in FIG. 3.

(Operation)

The control unit 6 of the on-board device 1 checks the history information 61 (Step 10). Then, when the biometric information 42 not having been used for authentication for a predetermined period is present (Step 11: Yes), the control unit 6 increases difficulty of authenticating the biometric information 42 not having been used for authentication (Step 12) and ends the process.

Meanwhile, when the biometric information 42 not having been used for authentication for a predetermined period is not present in Step 11 (Step 11: No), the control unit 6 ends the process.

### Effect of the Other Embodiment

The on-board device 1 in the other embodiment increases the difficulty of authenticating the biometric information 42 which has not been used for authentication. Therefore, unlike when such a configuration is not adopted, frequency of authentication using the biometric information 42 not having been used for authentication is reduced and it is thus possible to suppress an increase in time spent on authentication.

As a modification, in case of increasing the difficulty of authenticating the biometric information 42 not having been used for authentication for a predetermined period, the control unit 6 is configured to lower the priority of the biometric information not having been used for authentication.

In detail, for example, the control unit 6 gives the lowest priority to the fingerprint not having been used for authentication for a predetermined period so that authentication is likely to be successfully completed before such a fingerprint is used for authentication.

In addition, as another modification, the control unit 6 is configured to delete, after increasing the difficulty of authentication, the biometric information 42 from the storage unit 4 when the biometric information 42 not used for authentication is not used for authentication for a further predetermined period. The predetermined period is about one year, as an example.

The deletion of the biometric information 42 here includes a process of not retrieving the biometric information 42 from the storage unit 4. In this case, it may be configured such that the biometric information 42 is selected by the user and used as an authentication template again.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, all combinations of the features described in these embodiments and modifications are not necessary to solve the problem of the invention. Further, these embodiments and modifications are included within the scope and gist of the invention and also within the invention described in the claims and the range of equivalency.

### REFERENCE SIGNS LIST

1 ON-BOARD DEVICE
2 BIOMETRIC INFORMATION SCANNING UNIT
4 STORAGE UNIT
6 CONTROL UNIT
8 VEHICLE
40 TABLE
41 PERSONAL INFORMATION
42 BIOMETRIC INFORMATION
61 HISTORY INFORMATION

1. An on-board device, comprising:
a storage unit that stores biometric information of a user of a vehicle that is used for authentication; and
a control unit that increases difficulty of authenticating biometric information not having been used for authentication for a predetermined period or deletes such biometric information from the storage unit.

2. The on-board device according to claim 1, wherein, in case of deleting biometric information not having been used for authentication for a predetermined period from the storage unit, and when all biometric information stored in the storage unit have not been used for authentication, the control unit deletes personal information of all users stored in the storage unit together with all the biometric information.

3. The on-board device according to claim 1, wherein, in case of increasing difficulty of authenticating the biometric information not having been used for authentication for a predetermined period, the control unit increases a threshold for authenticating the biometric information not having been used for authentication.

4. The on-board device according to claim 1, wherein, in case of increasing difficulty of authenticating the biometric information not having been used for authentication for a predetermined period, the control unit lowers the priority of the biometric information not having been used for authentication.

5. The on-board device according to claim 3, wherein, after increasing the difficulty of authentication, the control unit deletes the biometric information from the storage unit when the biometric information not used for authentication is not used for authentication for a further predetermined period.

6. The on-board device according to claim 1, wherein the control unit selects the biometric information not having been used for a predetermined period, based on history information that is generated by arranging, among the biometric information of the users stored in the storage unit, biometric information used for authentication in time series and adding usage frequency information to each of the biometric information used for authentication.

7. The on-board device according to claim 1, further comprising a biometric information scanning unit that scans the biometric information of the user,
wherein the storage unit stores personal information including at least the biometric information of the user based on scanned information that is acquired from the biometric information scanning unit.

8. The on-board device according to claim 7, wherein the storage unit generates a table that associates the personal information with each of users sharing the vehicle.

9. The on-board device according to claim 8, wherein, when generating the table, the storage unit arranges the users in order of priority, and when each of the users resisters a plurality of biometric information, the storage unit arranges the biometric information of the user in order of priority.

10. The on-board device according to claim 7, wherein the biometric information scanning unit scans one or more selected from fingerprint, vein, pulse rate, blood pressure, facial image and iris as the biometric information of the user, and one or more selected from fingerprint, vein, pulse rate, blood pressure, facial image and iris is/are stored as the biometric information of the user in the storage unit.
